(19) United States
(12) Patent Application Publication
(10) Pub. No.: US 2005/0017171 A1
(43) Pub. Date: Jan. 27, 2005

(54) Probe structures incorporating nanowhiskers, production methods thereof and methods of forming nanowhiskers

(75) Inventors: Lars Ivar Samuelson, Malmo (SE); Bjorn Jonas Ohlsson, Malmo (SE)

Correspondence Address: MILES & STOCKBRIDGE PC, 1751 PINNACLE DRIVE, SUITE 500, MCLEAN, VA, 22102-3833, US

(73) Assignee: BTG International Limited

(21) Appl. No.: 10/751,943

(22) Filed: Jan. 7, 2004

Related U.S. Application Data
(60) Provisional application No. 60/485,104, filed on Jul. 8, 2003.

(51) Int. Cl. G01N 23/00

(52) U.S. Cl. 250/306

(57) ABSTRACT

A probe structure for a scanning probe microscope comprises a nanowhisker (16,34) projecting from a free end of an upstanding tip member (4,26), and being formed integrally with the tip member. In another embodiment, a data storage medium comprises an array of nanowhiskers (54), each nanowhisker being formed from magnetic material, the diameter of the nanowhisker being such that a single ferromagnetic domain exists within the nanowhisker, preferably having a diameter not greater than about 25 nm and more preferably not greater than about 10 nm, and a read/write structure comprising the probe structure for injecting a stream of spin-polarised electrons into a selected nanowhisker of the array, either for sensing the direction of magnetisation in the nanowhisker, or for forcing the nanowhisker into a desired direction of magnetisation. When the probe nanowhisker is formed by a VLS process using a catalytic particle melt, the whisker may be formed with a sacrificial segment to allow for removal of the catalytic material by selective etching of the segment.

### CROSS-REFERENCE TO RELATED APPLICATION

This application claims the benefit of U.S. Provisional Application No. 60/485,104 filed Jul. 8, 2003, which is incorporated herein by reference.

### FIELD OF THE INVENTION

The present invention relates to structures, incorporating one-dimensional nanoelements and which are suitable for use in scanning probe microscopy, current injection applications, and other applications. “One-dimensional nanoelements” are structures, essentially in one-dimensional form, that are of nanometer dimensions in their width or diameter, and which are commonly known as nanowhiskers, nanorods, nanowires, nanotubes, etc. More specifically, but not exclusively, the invention is concerned with structures incorporating nanowhiskers, related production methods, and to methods of forming nanowhiskers.

### BACKGROUND ART

The basic process of whisker formation on substrates, by the so-called VLS (Vapour-Liquid-Solid) mechanism is well known. A particle or mass of catalytic material, usually gold, is heated on a substrate in the presence of certain gases. The gases are absorbed by the catalytic mass to form an alloy. The alloy supersaturates, and a pillar of solidified material forms under the mass, and the mass rises up on top of the pillar. The result is a whisker of a desired material with the catalytic mass positioned on top. (See E. I Givargizov, Current Topics in Materials Science, Vol. 1, pages 79-145, North Holland Publishing Company, 1978.) The dimensions of such whiskers were in the micrometer range.

Although the growth of nanowhiskers catalyzed by the presence of a catalytic particle at the tip of the growing whisker has conventionally been referred to as the VLS (Vapour-Liquid-Solid process), it has come to be recognized that the catalytic particle may not have to be in the liquid state to function as an effective catalyst for whisker growth. At least some evidence suggests that material for forming the whisker can reach the particle-whisker interface and contribute to the growing whisker even if the catalytic particle is at a temperature below its melting point and presumably in the solid state. Under such conditions, the growth material, e.g., atoms that are added to the tip of the whisker as it grows, may be able to diffuse through a the body of a solid catalytic particle or may even diffuse along the surface of the solid catalytic particle to the growing tip of the whisker at the growing temperature. Evidently, the overall effect is the same, i.e., elongation of the whisker catalyzed by the catalytic particle, whatever the exact mechanism may be under particular circumstances of temperature, catalytic particle composition, intended composition of the whisker, or other conditions relevant to whisker growth. For purposes of this application, the term “VLS process”, or VLS mechanism, or equivalent terminology, is intended to include all such catalyzed procedures wherein nanowhisker growth is catalyzed by a particle, liquid or solid, in contact with the growing tip of the nanowhisker.

International Application Publication No. WO 01/84238 discloses in FIGS. 15 and 16 a method of forming nanowhiskers wherein nanometer sized particles from an aerosol are deposited on a substrate and these particles are used as seeds to create filaments or nanowhiskers.

For the purposes of this specification, the term nanowhiskers is intended to mean one-dimensional nanoelements with a diameter or cross-dimension of nanometer dimensions, preferably 500 nm or less.

Since the development of the Scanning Tunnelling Microscope in the 1980s there has been intense research in examining and processing surfaces at atomic dimensions by means of a tip of nanometer dimensions brought into close proximity or contact with the surface. The STM operates on a principle of a tunnelling current flowing between the tip and the sample surface, while moving the tip across the surface. Various other microscopes have been developed which operate on somewhat different principles for examining surfaces at the atomic level. These include, for example, the Atomic Force Microscope which relies on sensing of the electronic force of repulsion of the surface by means of a tip mounted on a flexible cantilever beam, microscopes which measure a magnetic force of attraction or repulsion by means of a magnetic tip, and microscopes which detect the heat generated by a sample surface, (see www.nanoworld.org). All of these microscopes fall into a generic class known as Scanning Probe Microscopes (SPM). For the purposes of this specification, the term Scanning Probe Microscope will be understood to include the Scanning Tunnelling Microscope, Atomic Force Microscope, and other microscopes which include a very fine tip moved over the surface of a specimen for determining characteristics of the surface on a nanometer or atomic scale.

The original form of STM comprised a tip mounted on a piezoelectric tube. The tunnelling current to a specimen surface was monitored, and the distance between the tip and the surface was adjusted to maintain the tunnelling current constant. Nowadays, the tip of such an STM commonly comprises a wire of Pt/Ir, the tip being formed by cutting and drawing the wire with cutters and pliers. Another common form of STM tip is a wire of Tungsten, whose end is etched. Both forms of tip have free ends with dimensions in the nanometer range.

A known construction of AFM uses a micromachined flexible cantilever beam of silicon with an integral silicon tip upstanding from the free end of the beam, the degree of flexure of the beam being measured as the tip is moved over the surface (see, for example, the McGraw Hill Encyclopaedia for Science and Technology 7^{th} Edition). The end of the tip commonly has dimensions in the nanometer range.

In Samuelson et al., Physica Scripta, vol. T42, pages 149-152, (1992), entitled “Tunnel-Induced Photon Emission in Semiconductors Using an STM”, there is shown in FIG. 6 an STM with a triangular semiconductor tip of gallium phosphide. Various types of tip material are proposed, as shown in FIG. 5, to permit tunnelling current of P-type or N-type carriers for achieving photon emission in the semiconductor surface. This is done by providing a tunnelling current formed of a narrow band of low energy electrons, that may be injected resonantly with specific electronic state features (e.g. bandgap) of the semiconductor surface that is to be probed by this device.

Carbon nanotubes have been proposed for the tips of SPM, as by gluing a carbon nanotube to the end of the cantilever beam. However, adhesive may fail, particularly when the SPM is immersed in fluid. Furthermore, such SPM-tips will, in principle, suffer from the same limitation as a conventional metallic SPM-tip, with the simultaneous injection from a very broad band of electron states from the tip.

The use of nanotechnology in magnetic applications is well known. See, for example, U.S. Pat. No. 5,997,832 and WO 97/31139 to Lieber, which describe nanorods of various materials, some of which are magnetic. The use of nanotechnology to develop thin films for data storage applications is described in Shouheng Sun et al, Science Vol. 287, 17 March 2000, entitled “Monodisperse FePt Nanoparticles and Ferromagnetic FePt Nanocrystal Superlattices”. In the area of Spintronics, problems arise in the efficient injection of spin-polarised electrons into the Spintronics device. It has been proposed to use an SPM with ferromagnetic tip for such injections by a vacuum tunnelling process. (Wolf et al., Science Vol. 294, pages 1488-1495, Nov. 16, 2001, at page 1491.) See also Orgassa et al., Nanotechnology 12; pages 281-284, (2001).)

### SUMMARY OF THE INVENTION

In a first aspect, the present invention provides a nanotechnological structure for use in a scanning probe microscope, comprising a tip member, and a nanowhisker projecting from a free end of the tip member, and being integral therewith.

There is thus provided a structure which may be used as a probe for a Scanning Tunnelling Microscope (STM), AFM, and other forms of SPM, with resulting technical advantages as set forth below. The tip member may be of any desired shape, for example tubular, conical or triangular. In a common form of STM, the tip member constitutes the end region of a metallic wire, and the nanowhisker may be formed on a prepared region at the wire end. Alternatively, the tip member may be formed as a separate member mounted on a substrate, or other appropriate support, depending on the intended application. Both the tip member and nanowhisker will usually be formed of conductive or semiconductive material, to permit current flow, but there may be circumstances where insulative material is employed, depending on the physical parameter used as a metric.

Measurements with STM are usually at the atomic scale for examining surface features in extreme detail. Measurements with AFM, on the other hand, are more commonly on a larger nanometer scale for examining engineered nanostructures. Where, as is commonly the case, the probe structure is intended for atomic force measurements, a tip support member may comprise a flexible elongate member or beam of predetermined dimensions and mechanical characteristics, in particular elasticity. The probe structure is then suitable for use in an Atomic Force Microscope (AFM). The tip member may be integral with the beam, where the beam is of a suitable material, e.g. silicon. Other forms of tip support member may be used, for example V-shaped support members.

More specifically therefore, the invention provides a nanotechnological structure, comprising a flexible support member, the support member having an upstanding tip member at or adjacent a free end of the support member, and a nanowhisker projecting from a free end of the tip member, and being integral therewith.

In a second aspect, the invention provides a method of forming a nanotechnological structure for a scanning probe, comprising:
providing a tip member; and
forming a nanowhisker projecting from the tip member.

In a preferred embodiment, the formation of the nanowhisker includes:
providing at the free end of the tip member a mass of catalytic material of predetermined volume; and
heating the mass and exposing the mass to gases of predetermined type under conditions such as to form, by the VLS process, a nanowhisker upstanding from the tip member.

It is possible and in accordance with the invention to have more than one nanowhisker formed at the end of the tip member. More than one tip member may be provided, each tip member having one or more nanowhiskers formed thereon. Such tip members may be mounted on a single support, or may be independently mounted for independent movement.

In at least one preferred embodiment of the invention, the tip member is mounted on a cantilever beam of silicon or other conductive or semiconductive material and has predetermined dimensions, usually in the micrometer range. The beam has predetermined mechanical characteristics, in particular a predetermined resilience in response to forces exerted on the end of the beam. The beam is formed with an upstanding tip member at its free end. Where the beam is of a suitable material such as Si, the tip member is formed integrally with the beam by a suitable process such as micromachining.

A nanowhisker is formed at the extreme end of the tip member and is preferably grown by the process described in our copending U.S. patent application Ser. No. 10/613,071 filed Jul. 7, 2003 and International Application No. PCT/GB03/002929, filed Jul. 8, 2003, the contents of which are incorporated herein by reference. An area of gold or other catalytic material is provided on the end of the tip member, as by a lithographic process, for example nanoimprint lithography (NIL), or by the deposition of a gold nanoparticle. When heated in epitaxy apparatus, the gold area coalesces and forms a catalytic melt. Gases introduced into the growth system are absorbed by the melt, and form a eutectic alloy. Upon supersaturation, a solidified material of desired composition, for example gallium arsenide, is deposited at the interface between the melt and the semiconductor crystal underneath. In this way a column is formed, and this column is termed a nanowhisker or nanowire.

A scanning probe microscope according to the invention has the feature that a very narrow energy distribution of injected carriers may be provided. A very accurate and sensitive tool for examination of a sample surface is therefore provided. This narrow energy distribution may be obtained by the use of a degenerately doped large band-gap semiconductor nanowire material (e.g. GaP, GaN, ZnO) that creates free electrons in the conduction band of the semiconductor, with an energy range of about 10 mev—this is essentially independent of the specific material. Alternatively, an even smaller energy distribution of about 1 mev may be obtained by the use of a designed resonant tunnelling structure in the nanowire, for example. A resonant tunnelling structure, consisting of a series of heterojunctions within the nanowire between materials of different bandgap, is fully described in our copending U.S. patent application Ser. No. 10/613,071 filed Jul. 7, 2003 and International Application PCT/GB03/002929, filed 8 July, 2003, the contents of which are herein incorporated by reference, and is essentially formed by the process described above, but that the gas constituents are rapidly switched during the growth of the nanowire to produce segments of different material.

In either case, the nanowhisker may have a constant diameter cross-section along its length, or, as preferred, a tapering/conical shape. The desired shape is created by appropriate adjustment of growth conditions, principally temperature, as described in our copending U.S. patent application Ser. No. 10/613,071 filed Jul. 7, 2003 and International Application PCT/GB03/002929, filed Jul. 8, 2003.

The nanowhisker may be made of very precise dimensions, particularly in diameter where it can be accurately dimensioned to a dimension of just a few nanometers, that is less than 10 nm. In general, the diameter of the nanowhisker may be predetermined preferably within the range 5-50 nm. Its length may typically be chosen to be anything between about 100 nm to several micrometers. The nanowhisker thus formed constitutes an element of precise dimensions and predetermined characteristics in the probe tip structure. When it is formed integrally (monolithically) with the cantilever beam by the above process, it is very secure and reliable in use, and further has a perfect, continuous and impedance-less electrical coupling to the rest of the probe structure. This is in contrast to, for example, arrangements employing carbon nanotubes glued onto a beam where there is a risk of losing the tip, particularly when immersed in fluid, and further where a significant electrical impedance may exist between the nanotube and the SPM.

A melt of catalytic material, remaining at the top of the nanowhisker, may in some circumstances be undesirable; for example, it may affect the energy distribution of a stream of electrons passing through the nanowhisker, and the shape of the whisker end may not be especially well-defined. In accordance with a further aspect of the invention, therefore, the melt may be removed. In a preferred embodiment, using the techniques described in our copending U.S. patent application Ser. No. 10/613,071 filed Jul. 7, 2003 and International Application PCT/GB03/002929, filed Jul. 8, 2003, the growth of the nanowhisker may be completed, by appropriate change in growth conditions and substituting different gases in the reaction chamber, to terminate the growth with a short segment of a “sacrificial” segment of a material which is different from the major or adjacent part of the nanowhisker. For example, the sacrificial material may be InAs where the whisker is GaAs, or GaAs where the whisker is InAs. This sacrificial material may be later removed by a selective etching, hence removing the catalytic (e.g., gold) particle and forming a fresh surface which terminates the whisker. Further, the etching may produce a whisker end which is sharply rounded or pointed, for further precision.

In a further aspect, the invention provides a process of forming a nanowhisker, comprising:
providing a mass of catalytic material, and exposing the mass to one or more gases under predetermined operating conditions to form by the VLS process a nanowhisker;
terminating the growth of the nanowhisker by changing at least one operating condition to provide at the end of the nanowhisker a segment of a different material from that of the remainder or at least an adjacent portion of the nanowhisker; and
after formation of the nanowhisker, selectively etching the different material so as to remove the different material and the mass of catalytic material there above.

As an alternative to gold catalytic material, the catalytic material may comprise a group-III-metal such as Ga or In, which metal is comprised in the material from which it is intended to form the nanowhisker. The nanowhisker may be formed simply of the group-III-metal alone, or the metal alloyed with a group-V-material to form a semiconductor compound. In either case, the catalytic melt which remains at the free end of the nanowhisker after the nanowhisker is formed is the same material as that of the remainder of the nanowhisker, and this may be of advantage in some situations.

The present invention envisages use of probe structures in bio sensing applications. A bio sensing technique may be regarded as any sensor method which utilises bio molecules such as, inter alia, nucleic acid, proteins or antibodies or fragments, binding or amplification interactions being typical. A nanowhisker incorporated into an SPM tip, in accordance with the invention, may have a coating for binding predetermined molecules thereto, or the coating including biologically active molecules.

A nanowhisker incorporated into an SPM tip in accordance with this aspect of the invention is particularly adapted as a highly localised sensor for sensing parameters of biological molecules, e.g. DNA. For example, such molecules may be positioned on a substrate, and an AFM may be arranged to scan over the surface of the substrate, and map properties of the DNA. Further, the nanowhisker incorporated into the SPM tip may be formed of silicon or other oxidisable material. The nanowhisker is oxidised to form a surrounding layer of oxide along its length, but with the gold or other catalytic seed particle melt at the free end of the nanowhisker remaining free of oxide. This therefore provides a highly accurate probe for examining biological surfaces, where the interaction occurs within a precisely defined region. This permits mapping of molecules in a height direction, as well as planar directions, thus enabling a three dimensional XYZ mapping.

Further, and in accordance with the invention, a nanowhisker incorporated in an SPM tip may have a series of segments of different material along its length, such as to create between heterojunctions a light emitting diode of very small dimensions, for example, as small as 20 nm³. The wavelength of such a diode may be predetermined to a desired value by appropriate choice of materials and dimensions. Such diode, when appropriately energised, can be arranged to emit a single photon as and when required, and this can be employed to irradiate a biological sample (e.g. tissue, cell or molecule). The irradiation of biological samples with electromagnetic radiation is an extremely sensitive tool for determining optical absorbance of molecules, phosphorescence, luminescence, etc.

As regards magnetic applications, in the present invention, a probe tip structure having a nanowhisker is of use for current injection purposes into an electrical circuit, where the electrons forming the electric current should have precisely determined parameters of spin. For example, where the nanowhisker is formed of a magnetic material such as MnInAs, MnGaAs, MnAs, or a semimagnetic material, spin polarised electrons may be emitted from the tip of the whisker (a semimagnetic material is a semiconductor compound containing a dilute concentration of magnetic ions, e.g. Mn). Whilst the tip structure may be provided on any suitable support member, e.g. a rigid substrate or metal wire, it is preferred to use a cantilever beam construction, as the resilience of the beam gives a reliable contact, and the dimensions of the beam and tip structure are compatible with the dimensions of the circuit into which the electrons are injected.

As an alternative, the cantilever beam and tip member are formed of ferromagnetic material for polarising and alignment of the electron spins prior to the electrons entering the nanowhisker. The nanowhisker may then act as a conduit for the spin polarised electron stream. This may be an advantage where it is inconvenient to form the nanowhisker of a ferromagnetic material.

A further aspect of the invention is based on an array of nanowires or nanowhiskers formed of an appropriate magnetic material and employed as a data storage medium, wherein each nanowire may be selectively magnetised in a spin-up or spin-down condition to represent a “1” or “0” bit.

With regard to ferromagnetic properties, nanowhiskers may present a possibility for retaining ferromagnetism in very small regions. There is much interest in magnetic memory devices employing very small, typically single-domain, magnetic particles, or similar structures, as memory elements. However, it is known that as the size of a ferromagnetic single domain is reduced a limit is reached below which the ferromagnetic state cannot exist, and the domain, e.g., the single particle, assumes the superparamagnetic state in which the magnetic moments of all the atoms still line up to form the collective huge magnetic moment as in a ferromagnet, but where the orientation of this huge spin is no longer locked into a defined direction as it is in a ferromagnet. This limit is typically about 50 nm for a spherical magnetic particle. However, when a magnetic domain, e.g., a ferromagnetic domain, is incorporated into a nanowhisker, the diameter at which the domain ceases to be ferromagnetic and undergoes a transition to the superparamagnetic state can be reduced, because the substantially one-dimensional character of the nanowhisker tends to restrict the possible reorientation of the magnetic moment of the ions (or atoms) of the magnetic material. The material of the whisker can be made of iron, cobalt, manganese, or an alloy thereof. Other possible materials include manganese arsenide (ferromagnetic). Accordingly, it is possible to reduce the size of a ferromagnetic domain formed in a nanowhisker to less than the conventional lower limit for a particular material. Thus, ferromagnetic properties may be retained, at least for some magnetic materials, at transverse dimensions of 10 nm or less by forming them into nanowhiskers having a diameter of 10 nm or less. Such very small ferromagnetic elements have evident uses in the field of magnetic memory devices.

Thus it is possible in accordance with the invention to prepare smaller magnetic memory elements that can be selectively magnetized and produce a magnetic flux that can be sensed. The reduced symmetry in the nanowire (or nanowhisker) geometry may make possible a higher Curie temperature for magnetic semiconductor materials. Furthermore, the freedom in combining materials (inside a whisker) having different lattice constants may enhance the use of new magnetic semiconductors for these applications, such as MnGaP and MnGaN, which may have Curie-temperatures above room-temperature. Alternatively, metallic ferromagnetic materials including elements such as Fe, Co, Ni may be employed.

In general, the invention may be practised with a ferromagnetic material, a semimagnetic material (a dilute solution of magnetic ions in a semiconductor matrix), or other appropriate magnetic material, such as ferrimagnetic.

In a further aspect therefore, the present invention provides a nanowhisker comprising magnetic material, the diameter of the nanowhisker being such that a single ferromagnetic domain exists within the nanowhisker. Preferably the diameter of the nanowhisker is not greater than about 25 nm, preferably not greater than about 10 nm.

The nanowhiskers produced in accordance with the invention may be essentially cylindrical and have a constant diameter, or may have a slightly tapered form, depending on the precise nanowhisker growth conditions. Where the diameter is not strictly constant along the length of the nanowhisker, the diameter of the nanowhisker is to be regarded as an average value.

In a further aspect, the present invention provides a data storage medium comprising an array of nanoelements, preferably nanowhiskers, each including magnetic material, and read/write structure for selectively magnetising each nanowhisker in either of first and second magnetised directions and sensing the magnetised direction of each nanowhisker.

The sensing device preferably comprises an SPM type arrangement, with a cantilever support provided with a tip member and nanowhisker for providing a stream of spin-polarised electrons, as described above. Such tip structure (tip member and nanowhisker) may be moved across the array to scan the nanoelements, and may be selectively positioned in alignment with an element, in order to sense the direction of magnetisation. The impedance of the element to current flow provides an indication of magnetisation direction. The device for writing magnetisation direction may comprise the device for sensing, but wherein the magnitude of the spin polarised current is greatly increased to force the nanoelement into a desired magnetisation direction. Alternatively, a separate writing head may be provided which comprises, merely by way of example, a tip which can be strongly magnetised to selectively magnetise, by means of its magnetic field, the nanoelements.

In a further aspect, the invention provides a method forming a data storage medium, comprising:
forming volumes of catalytic material at predetermined sites on a substrate; and
growing at each site, a nanowhisker of magnetic material and of such dimensions that only a single ferromagnetic domain exists within the nanowhisker.

### BRIEF DESCRIPTION OF THE DRAWINGS

Preferred embodiments of the invention will now be described with reference to the accompanying drawings wherein:

FIGS. 1-1f show steps in the process of formation of a tip for an atomic force microscope (AFM), forming a first embodiment of the invention;

FIGS. 2a and 2b show a second embodiment of the invention comprising a tip for a scanning tunnelling microscope (STM),

FIG. 3 shows a third embodiment of the invention adapted for determining properties of biological samples;

FIG. 4 shows a fourth embodiment of the invention comprising a nanostructure that forms a mechanism for current injection of spin polarised electrons into a Spintronics circuit;

FIGS. 5a-5c show a fifth embodiment of the invention comprising an array of nanowhiskers of magnetic material forming a data storage medium; and

FIGS. 6a-6e show a process for forming the nanowhisker array.

### DESCRIPTION OF THE PREFERRED EMBODIMENTS

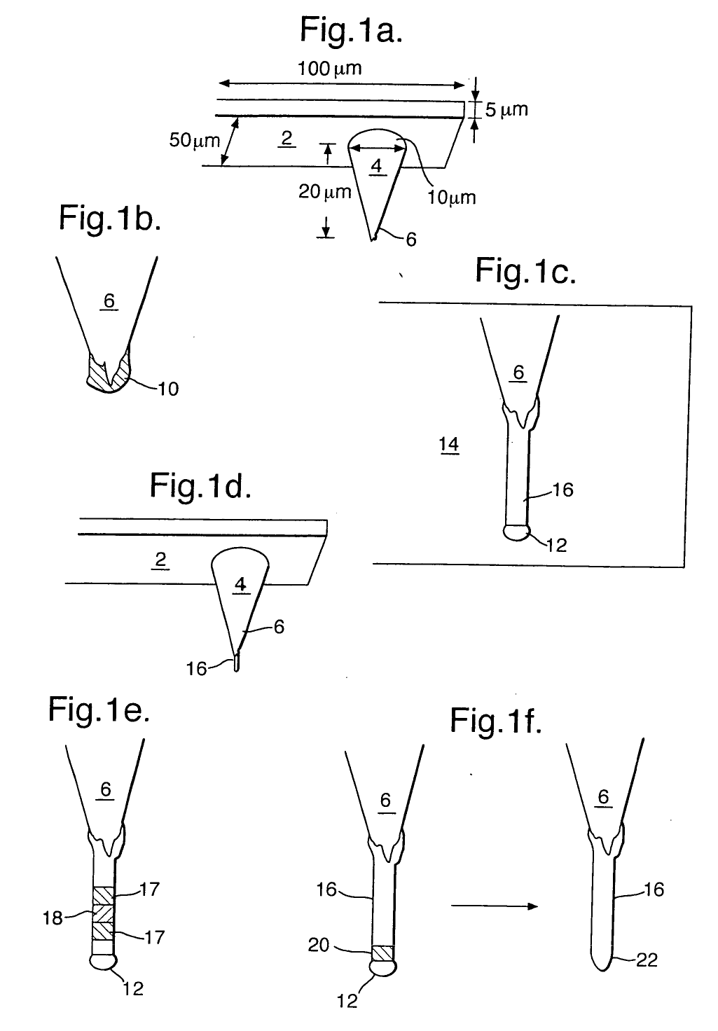

Referring now to FIG. 1a, a tip for an AFM comprises a beam of silicon 2 which is micro-machined (for example by etching) to form a rectangular elongate bar of a length, for example between 100 and 500 μm, and having a rectangular cross-section 50×5 μm. This provides a bar with a predetermined resilience to flexure. This resilience makes the structure suitable for use in an AFM. At one end of the beam 2, a conical tip 4 is formed integrally with the beam, with a base 10 μm wide and a height of 20 μm. The extreme end 6 of tip 4 has a dimension about 20 nm across.

As shown in FIG. 1b, a volume 10 of gold is affixed to the end 6 of the tip. A variety of techniques may be employed for carrying out this step. For example, the gold 10 may be electrolytically plated by immersing the end 6 in a solution containing gold ions and employing the tip as one electrode of a pair of electrodes, with a voltage applied between the electrodes. Alternatively, a beam of molecules may be directed at the end 6, in molecular beam apparatus. The molecules are of organometallic type containing gold ions. Under appropriate operating conditions, the incident molecules fragment at the end 6, with the gold ions bonding to the end 6. As a further alternative, an aerosol droplet of gold may be affixed to the end of the tip by exposing the tip to such aerosol. Desirably a voltage is applied to the tip, to attract droplets via the electric field in the region of end 6. None of these techniques is illustrated, since their implementation would be straightforward for a person skilled in the art.

After formation of the gold volume 10 on end 6, the beam 2 is then moved into a Chemical Beam Epitaxy (CBE) apparatus 14, FIG. 1c. The beam is heated to a temperature of around 400° C. so that the gold melts and coalesces into a particle 12. A beam of organic molecules containing gallium, TMGa (trimethylgallium) or TEGa (triethylgallium) is then injected into the source chamber 14, and a gas containing arsenide ions, for example TBAs (tributylarsine) or AsH₃, is introduced into the chamber. The TBAs material is decomposed by the high temperature employed whereas the group III molecules, TMGa or TEGa are broken down at the sample surface. In any event gallium and arsenic atoms are absorbed by the gold catalytic particle 6 to form a eutectic alloy. Upon further absorption, the eutectic alloy supersaturates and gallium arsenide is deposited between the particle 12 and the surface of the tip free end, whereby to form a nanowhisker column 16. This process is more fully described in our International Application PCT/GB03/002929, filed 8 Jul. 2003. Depending on the temperature employed, the nanowhisker may be perfectly cylindrical, or, as preferred, it may be formed conically. The diameter of the nanowhisker depends on the initial area of the gold 10 and the resultant diameter of the particle 12. The resultant AFM tip is shown in FIG. 1d.

There is thus formed, as shown schematically in FIG. 1d, a tip for an atomic force microscope or other microscopic instrument with the novel property that a very narrow energy distribution of injected carriers may be designed and controlled. This narrow energy distribution may be obtained by the use of a degenerately doped large band-gap semiconductor nanowire material (e.g. GaP, GaN, ZnO). that creates free electrons in the conduction band of the semiconductor, with an energy range of about 10 mev—this is essentially independent of the specific material. Alternatively, an even smaller energy distribution of about 1 mev may be obtained by the use of a designed resonant tunnelling structure in the nanowire. A resonant tunnelling structure, consisting of a series of heterojunctions within the nanowire between materials of different bandgap, is fully described in our Copending U.S. application Ser. No. 10/613,071 and International Application PCT/GB03/002929, filed 8 Jul. 2003, the contents of which are herein incorporated by reference, and is essentially formed by the process described above, but that the gas constituents are rapidly switched during the growth of the nanowire to produce segments of different material. This is shown schematically in FIG. 1e, where the nanowhisker 16 comprises segments 17 of wide band gap material bounding a conductive segment 18 of low band gap material in order to form a resonant tunnelling diode (RTD).

In an alternative construction, the material of the segment 18, and its width along the length of the nanowhisker, are selected in order to produce a light emitting diode of a particular wavelength, as more fully described with reference to FIGS. 15 and 16 of International Application PCT/GB03/002929, filed 8 Jul. 2003. The diode may be so small (20 nm³) that it may be regarded as a point source, and the diode may be accurately controlled so as to be capable of emitting single photons “on demand”. This may be of use in mapping and scanning biological molecules, as described above.

In an alternative construction, as shown in FIG. 1f, a short segment 20 of a sacrificial material such as InAs is formed at the end of a GaAs nanowhisker, by rapidly switching the constituents of the gas in the CBE chamber. A subsequent etching process with a suitable acid removes the segment 20, and the gold particle melt 12. The remaining nanowhisker 16 is of the same material throughout in this example (although it may include portions or segments of different materials), and has a well-defined end, the etching process producing a pointed or sharply rounded end 22. The diameter of the wire at its end may be between 5 and 25 nm. Whilst the whisker could in principle be made of smaller diameter, it has been found that this range is suitable for the intended applications of an AFM. This construction is of advantage where it is necessary to have a well-defined stream of electrons flowing through the nanowhisker.

Although as described above, the AFM tip has a flexible cantilever beam, this is not strictly necessary for other applications, and a rigid substrate or other support member may replace the beam.

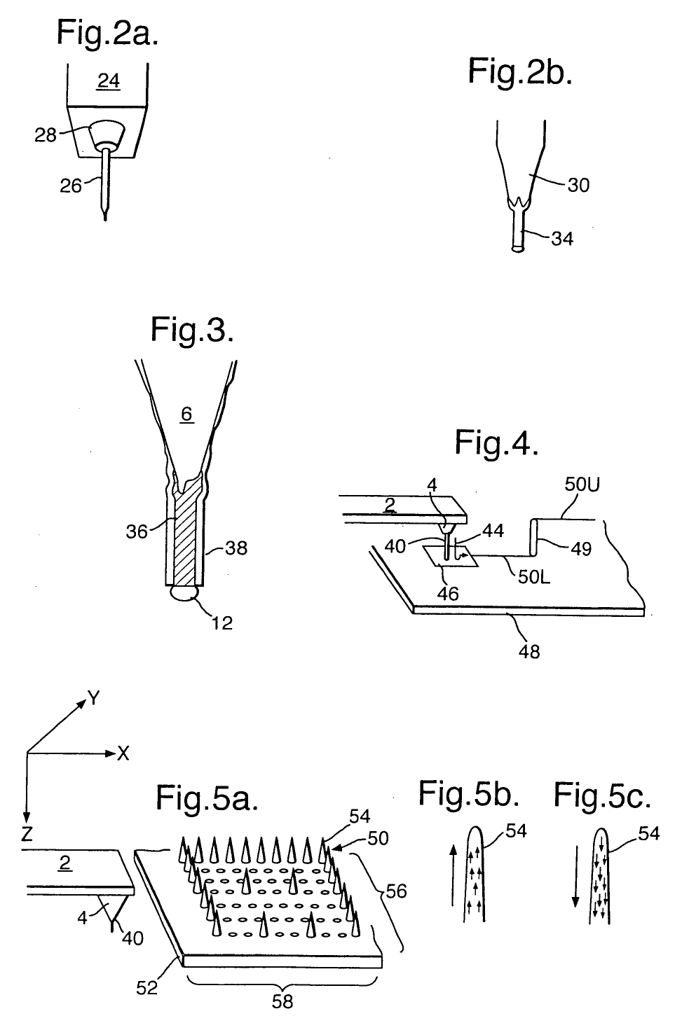

FIGS. 2 and 2b show a probe for an STM according to a second embodiment of the invention. In FIG. 2a, a support 24 mounts an STM tip structure comprising a metallic wire tip member 26 held in a holder 28. The end of the wire 26, as shown in FIG. 2b, is tapered as at 30. A nanowhisker 34 is formed at the end, in accordance with the processes described above with reference to FIGS. 1b to 1g. Since STM applications usually require measurements of an atomic scale, the nanowhisker may have a very small diameter, at least at its tip, say 10 nm or less, or even less than 5 nm.

Referring now to FIG. 3, a third embodiment is shown comprising a tip structure of an AFM, with integral nanowhisker, where similar parts to those of FIG. 1 are denoted by the same reference numerals. A nanowhisker 36 is formed by the method described above. The whisker is formed of silicon and has a gold particle melt 12 at one end. Subsequent to formation of the whisker, the whisker is exposed to an atmosphere at a suitable temperature for oxidation of the silicon. This forms an outer shell 38 of silicon dioxide surrounding the whisker and extending along its length. The gold particle melt 38 remains in an unoxidised condition.

This therefore provides a structure highly suitable for precise examination of biological samples, since the region of interaction with the biological sample is very precisely defined. The nanowhisker 36, 38, 12 may be used, for example, to map properties of biological tissue in three directions of movement of the tip structure, X, Y, Z.

As an alternative, the whisker 36 may be exposed to an atmosphere of a suitable material for forming a high band gap material as an alternative to the oxidation layer 38. The gold particle melt 12 may in either case be coated with an enzyme material or other biologically active material, in order to create desired reactions with biological samples.

In an alternative construction for three dimensional mapping and characterisation of biological tissue, a light emitting diode is formed within a nanowhisker 16, 17, 18, as described above with reference to FIG. 1e. The interaction of light with biological tissue provides a highly sensitive tool for characterising the tissue, particularly where the diode is so small (20 nm³) that it may be regarded as a point source, and where the diode is capable of emitting single photons “on demand”.

Referring now to FIG. 4, a fourth embodiment of the invention is shown for use in the field of Spintronics. Spintronics is a technical field where the properties of electronic devices rely on the transport of electron spin through the device. In FIG. 4 similar parts to those of FIG. 1 are denoted by similar reference numerals. A whisker 40, formed at the end of the tip member 4, by the process described above, is of a magnetic material (MnInAs, MnGaAs, MnAs) or semimagnetic material, containing a dilute concentration of Mn. Under an applied voltage V, spin polarised electrons 44 are emitted from the tip of the whisker, which makes electrical contact with an electrical contact 46 disposed on a substrate 48. The spin polarised electrons 44 are injected by means of a tunnelling process into contact 46 and are then used for a desired function, such as reading the state of a magnetic memory element, such as nanopillar 49 disposed on substrate 48 and electrically connected by means of lower and upper electrical conductors diagrammatically shown at 50L and 50U respectively.

In a fifth embodiment, as shown in FIG. 5a, a regular array of nanowhiskers 50 is formed on a substrate 52. Only a small part of a practical array is shown in FIG. 5a, and, for clarity, only the sites of many of the nanowhiskers are indicated. Each nanowhisker 54 is of a diameter 20 nm and is formed of a magnetic material (e.g. Fe, Co, Mn, MnAs, MnGaAs, MnInAs) which consists of a single ferromagnetic domain and may be in spin-up condition as shown in FIG. 5b or a spin-down condition as shown in FIG. 5c. When incorporated in a nanowhisker, in accordance with the invention, the domain diameter can be reduced because of the reduced possibilities for geometrical symmetrical alignment in a one-dimensional system, which makes it more difficult for the ions of the material to have more than one orientation. The material of the whisker can include iron, cobalt, manganese, or an alloy thereof.

The array 50 is arranged as a square matrix with rows and columns 56, 58. Each nanowhisker is 20 nm in diameter, and is spaced by a distance of 10 nm from adjacent nanowhiskers in row and column directions. In general, the spacing between adjacent nanowhiskers should be less than twice their diameter. This value represents a compromise between the requirement for the nanowhiskers to be as closely packed as possible, and a requirement that the nanowhiskers be sufficiently well spaced that they may be individually monitored. Instead of a rectangular matrix, the nanowhiskers may be arranged in any desirable configuration, such as a hexagonal lattice configuration (hexagonal close packed), or even a linear arrangement. A cantilever & tip arrangement 2, 4, 40, similar to that of FIG. 4, is employed as a read/write head which is movable over the array to scan the array in row and column directions X, Y. The head movement is controlled by conventional SPM techniques for selective positioning directly overhead in alignment with each nanowhisker.

In a read or sensing mode, the head 2, 4, 40 emits a weak current of spin-polarised electrons into the adjacent nanowhisker. The impedance of the nanowhisker to current flow provides an indication of magnetisation direction.

In a write mode, the magnitude of the current of spin polarised electrons emitted from the head is greatly increased and is sufficient, when flowing through the nanowhisker, to force the nanowhisker into a desired direction of magnetisation.

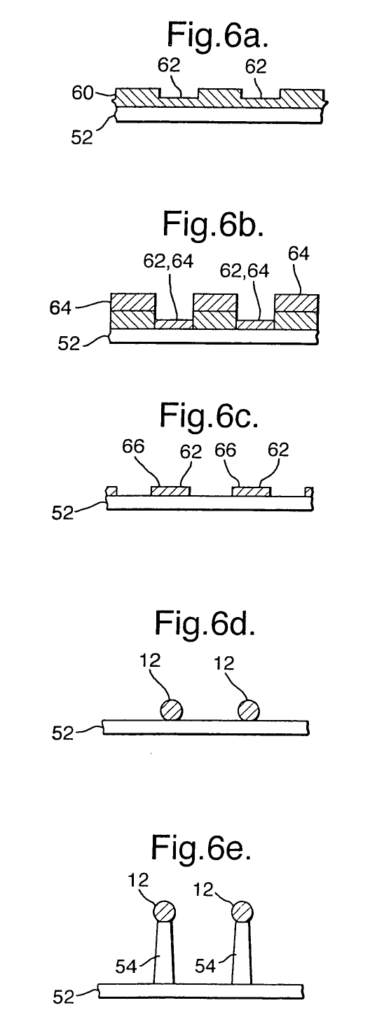

As regards the process of forming the array of nanowhiskers, gold catalytic areas are formed on substrate 52 by a NIL process at the desired sites of the nanowhiskers 54. This is shown in FIGS. 6a-e, which are sectional views of part of a row of sites. In FIG. 6a, substrate 52 has formed on its upper surface a layer of deformable polymer 60. The polymer has been deformed by a rigid stamp (not shown) to form rectangular depressions at the intended sites 62 of the nanowhiskers. The polymer is then etched, so as to remove the polymer in the site depressions 62, and a layer of gold 64 is applied. The result is shown in FIG. 6b, where the gold 64 makes contact with the substrate at the sites, and is elsewhere disposed on top of the remaining polymer 60. Finally, as shown in FIG. 6c, a further etching step removes the remaining polymer areas, to leave gold regions 66 at the nanowhisker sites 62.

The substrate is then transferred to a epitaxial growth reaction chamber, where heat is applied to make the gold areas coalesce into particles 12, as indicated in FIG. 6d. Gases are introduced into the reaction chamber, and nanowires 54 are grown by the VLS process, FIG. 6e. The nanowires are precisely formed, and are precisely located at the desired locations. If desired, a subsequent etching step may remove the gold particles at the end of the nanowires as previously described.

1. A nanotechnological structure for a scanning probe microscope, comprising a tip member, upstanding from a support member, and a nanowhisker grown on and projecting from a free end of the tip member.

2. A structure according to claim 1, wherein the support member comprises a flexible member of predetermined dimensions and mechanical characteristics, the upstanding tip member being located at or adjacent a free end of the flexible member.

3. A structure according to claim 2, wherein the flexible member comprises an elongate beam.

4. A structure according to claim 1, wherein the nanowhisker comprises doped large band gap semiconductor material, to provide in use a narrow energy distribution of electrons flowing therethrough.

5. A structure according to claim 1, wherein the nanowhisker comprises a resonant tunnelling diode structure including a sequence of segments of semiconductor material of different band gaps.

6. A structure according to claim 1, wherein the nanowhisker comprises a light emitting diode structure including a sequence of segments of semiconductor material of different band gaps.

7. A structure according to claim 1, wherein a coaxial layer of material that is inert to biological material is provided along a length of the nanowhisker.

8. A structure according to claim 7, wherein the nanowhisker is formed of silicon, and the coaxial layer is silicon dioxide.

9. A structure according to claim 1, wherein the nanowhisker is formed of a magnetic material or semimagnetic material and capable of providing a stream of spin-polarised electrons.

10. A structure according to claim 9, wherein the nanowhisker comprises one of: MnInAs or MnGaAs or MnAs.

11. A structure according to claim 9, wherein the nanowhisker has only a single ferromagnetic domain.

12. A structure according to claim 2, wherein the flexible member is formed of a magnetic material.

13. A nanotechnological structure, comprising a flexible support member, the support member having an upstanding tip member formed at or adjacent a free end of the support member, and a nanowhisker grown on a free end of the tip member.

14. A structure according to claim 13, wherein the flexible support member comprises an elongate beam.

15. A structure according to claim 13, wherein the nanowhisker comprises doped large band gap semiconductor material, to provide in use a narrow energy distribution of electrons flowing therethrough.

16. A structure according to claim 13, wherein the nanowhisker comprises a resonant tunnelling diode structure including a sequence of segments of semiconductor material of different band gaps.

17. A structure according to claim 13, wherein the nanowhisker comprises a light emitting diode structure including a sequence of segments of semiconductor material of different band gaps.

18. A structure according to claim 13, wherein a coaxial layer of material that is inert to biological material is provided along a length of the nanowhisker.

19. A structure according to claim 18, wherein the nanowhisker is formed of silicon, and the coaxial layer is silicon dioxide.

20. A structure according to claim 13, wherein the nanowhisker is formed of a magnetic material or semimagnetic material and capable of providing a stream of spin-polarised electrons.

21. A structure according to claim 20, wherein the nanowhisker comprises one of: MnAs or MnInAs or MnGaAs.

22. A structure according to claim 20, wherein the nanowhisker has only a single ferromagnetic domain.

23. A structure according to claim 13, wherein the support member is formed of a magnetic material.

24. A method of forming a nanotechnological structure for a scanning probe microscope, comprising:
providing a tip member;
providing at a free end of the tip member a mass of catalytic material; and
heating the mass and exposing the mass to gases of predetermined type under conditions such as to form, by a VLS process, a nanowhisker upstanding from the tip member.

25. A method according to claim 24, wherein the mass of catalytic material includes material provided on the tip member free end by an electrolytic process.

26. A method according to claim 24, wherein the mass of catalytic material includes material provided on the tip member free end by depositing an aerosol particle thereon.

27. A method according to claim 24, wherein the nanowhisker is formed of doped large band gap semiconductor material, to provide in use a narrow energy distribution of electrons flowing therethrough.

28. A method according to claim 24, wherein the nanowhisker is formed to include a resonant tunnelling diode structure having a sequence of segments of semiconductor material of different band gaps.

29. A method according to claim 24, wherein the nanowhisker is formed to include a light emitting diode structure having a sequence of segments of semiconductor material of different band gaps.

30. A method according to claim 24, wherein the nanowhisker is formed of a magnetic material or semimagnetic material and capable of providing a stream of spin-polarised electrons.

31. A method according to claim 30, wherein the nanowhisker comprises one of: MnAs, MnInAs or MnGaAs.

32. A method according to claim 30, wherein the nanowhisker has only a single ferromagnetic domain.

33. A method according to claim 24, wherein the tip member is mounted on a flexible support member of predetermined dimensions and wherein the flexible support member is formed of a magnetic material.

34. A method according to claim 24, wherein the catalytic material is of a same material as the nanowhisker.

35. A method according to claim 24, wherein the nanowhisker is formed of an oxidisable material, and the method further comprises exposing the nanowhisker to an oxidising environment so as to form a coaxial oxide layer along a length of the nanowhisker.

36. A method according to claim 24, further comprising:
terminating growth of the nanowhisker by changing at least one operating condition to provide at the end of the nanowhisker a segment of a different material from that of an adjacent portion of the nanowhisker; and
selectively etching the different material so as to remove the different material and the catalytic material from the nanowhisker.

37. A method of forming a nanotechnological structure, comprising:
providing an upstanding tip member at or near a free end of a flexible support member of predetermined dimensions and mechanical characteristics;
providing at a free end of the tip member a mass of catalytic material; and
heating the mass and exposing the mass to gases of predetermined type under conditions such as to form, by a VLS process, a nanowhisker upstanding from the tip member.

38. A method according to claim 37, wherein the support member comprises an elongate beam.

39. A method according to claim 38, wherein the mass of catalytic material includes material provided on the tip member free end by an electrolytic process or by deposition of an aerosol particle.

40. A method according to claim 37, wherein the nanowhisker is formed of doped large band gap semiconductor material, to provide in use a narrow energy distribution of electrons flowing therethrough.

41. A method according to claim 37, wherein the nanowhisker is formed to include a resonant tunnelling diode structure having a sequence of segments of semiconductor material of different band gaps.

42. A method according to claim 37, wherein the nanowhisker is formed to include a light emitting diode structure having a sequence of segments of semiconductor material of different band gaps.

43. A method according to claim 37, wherein the nanowhisker is formed of a magnetic material or semimagnetic material and capable of providing a stream of spin-polarised electrons.

44. A method according to claim 43, wherein the nanowhisker comprises one of: MnAs or MnInAs or MnGaAs.

45. A method according to claim 43, wherein the nanowhisker has only a single ferromagnetic domain.

46. A method according to claim 37, wherein the support member is formed of a magnetic material.

47. A method according to claim 37, wherein the catalytic material is of a same material as the nanowhisker.

48. A method according to claim 37, wherein the nanowhisker is formed of an oxidisable material, and the method further comprises exposing the nanowhisker to an oxidizing environment so as to form a coaxial oxide layer along a length of the nanowhisker.

49. A method according to claim 37, further comprising:
terminating growth of the nanowhisker by changing at least one operating condition to provide at an end of the nanowhisker a segment of a different material from that of an adjacent portion of the nanowhisker; and
selectively etching the different material so as to remove the different material and the catalytic material from the nanowhisker.

50. A process of forming a nanowhisker, comprising:
providing a mass of catalytic material, and exposing the mass to one or more gases under predetermined operating conditions to form, by a VLS process, a nanowhisker;
terminating a growth of the nanowhisker by changing at least one operating condition to provide at an end of the nanowhisker a segment of a different material from that of an adjacent portion of the nanowhisker; and,
selectively etching the different material so as to remove the different material and the catalytic material from the nanowhisker.

51. A process according to claim 50, wherein the end of the nanowhisker is etched to produce a sharply rounded or pointed end.

52. A nanowhisker formed of magnetic material, wherein only a single ferromagnetic domain exists within the nanowhisker, and a diameter of the nanowhisker is less than about 25 nm.

53. A data storage medium comprising nanowhiskers formed on a substrate, each nanowhisker being formed of magnetic or semimagnetic material, and read/write structure operative to selectively energise each nanowhisker in either of two magnetised directions and to sense the magnetised direction of each nanowhisker.

54. A data storage medium according to claim 53, wherein each nanowhisker has only a single ferromagnetic domain.

55. A data storage medium according to claim 53, wherein each nanowhisker has a diameter not greater than about 25 nm.

56. A data storage medium according to claim 53, wherein said read/write structure comprises at least one head movable over the nanowhiskers and selectively positionable over each nanowhisker to inject a current of spin-polarised electrons therein.

57. A data storage medium according to claim 56, wherein said head is a read/write head, and wherein in a writing mode, said head is operable to inject a sufficiently strong current of spin polarised electrons into the selected nanowhisker for forcing a desired direction of magnetisation into the nanowhisker.

58. A data storage medium according to claim 56, wherein said head comprises a nanotechnological structure including a tip member of conductive or semiconductive material, and a nanowhisker projecting from an end of the tip member, and being integral therewith.

59. A data storage medium according to claim 58, wherein said tip member is disposed on a flexible support member.

60. A data storage medium according to claim 59, wherein one of the flexible support member and nanowhisker comprises a magnetic or semimagnetic material capable of providing a stream of spin polarised electrons.

61. A data storage medium according to claim 53, wherein each nanowhisker is spaced from each of its nearest neighbours by a distance less than twice its diameter.

62. A data storage medium comprising one-dimensional nanoelements formed on a substrate, each nanoelement being formed from magnetic or semi-magnetic material, reading/writing structure for selectively magnetising each nanoelement in either of first and second oppositely magnetised directions, and for sensing the magnetised direction of each nanoelement, the reading/writing structure comprising a head movable over the nanoelements and being selectively positionable over each nanoelement for injecting a current of spin-polarised electrons therein, and the head comprising a nanotechnological structure including a tip member of conductive or semiconductive material, and a nanowhisker projecting from an end of the tip member, and being integral therewith.

63. A method forming a data storage medium, comprising:
forming masses of catalytic material at predetermined sites on a substrate; and
growing at each site a nanowhisker of magnetic or semi-magnetic material such that only a single ferromagnetic domain exists within the nanowhisker.

64. The nanowhisker of claim 52 having a diameter not greater than about 25 mm.

65. The nanowhisker of claim 52 having a diameter not greater than about 10 nm.

66. The data storage medium according to claim 53, wherein each nanowhisker has a diameter not greater than about 10 nm.
